(19) United States
(12) Patent Application Publication
(10) Pub. No.: US 2002/0093160 A1
(43) Pub. Date: Jul. 18, 2002

(54) Juvenile stroller with portable cooler

(76) Inventor: Andrew Mendenhall, Indianapolis, IN (US)

Correspondence Address: Richard A. Rezek, Barnes & Thornburg, 11 South Meridian Street, Indianapolis, IN, 46204, US

(21) Appl. No.: 09/938,951

(22) Filed: Aug. 24, 2001

Related U.S. Application Data
(60) Provisional application No. 60/261,605, filed on Jan. 12, 2001.

(51) Int. Cl. B62B 7/00; B62B 9/00

(52) U.S. Cl. 280/47.38; 280/647

(57) ABSTRACT

A juvenile stroller includes a stroller frame and a cooler configured to store items in a cooled environment. The cooler is attachable to and detachable from a basket support frame included in the stroller frame. Clips included in the cooler can be coupled to anchor mounts on the basket support frame to support the cooler in a traveling position alongside the rear wall of a storage basket coupled to the basket support frame.

This application claims priority under 35 U.S.C. 119(e) to U.S. Provisional Application Serial No. 60/261,605, filed Jan. 12, 2001, which is expressly incorporated by reference herein.

### BACKGROUND AND SUMMARY OF THE INVENTION

The present invention relates to juvenile strollers, and particularly to stroller accessories. More particularly, the present invention relates to storage units adapted to be carried onboard a juvenile stroller.

Juvenile strollers are being adapted to carry various child-care items in handy onboard locations in addition to carrying infants or other young children. Caregivers appreciate the convenience of being able to store child-care items onboard the stroller so that those items will be available to the caregiver when the stroller is being used to transport a child away from home or vehicle.

According to the present disclosure, a juvenile stroller includes a stroller frame and a thermally insulated cooler configured to store items in a temperature-controlled environment. The cooler is coupled to the stroller frame to move therewith.

In preferred embodiments, attachment means is provided for temporarily coupling the cooler to the stroller frame so that the cooler is attached to the stroller frame to move therewith and is detachable from the stroller frame at the option of a user. The attachment means includes a pair of anchor mounts fixed to the stroller frame and a clip coupled to each end of the cooler and arranged to be coupled to one of the anchor mounts to link the cooler to the stroller frame.

In a presently preferred embodiment, a storage basket is supported on a basket support frame located under a seat mounted on a portion of a seat frame. Each anchor mount is coupled to a comer portion of the basket support frame so that a rear wall of the storage basket lies between the two spaced-apart anchor mounts. Each clip is coupled to one of the anchor mounts to support the cooler in a traveling position alongside the rear wall of the storage basket so as to be accessed easily by a caregiver pushing the stroller.

A carrying strap is also provided to make it easy for caregivers to carry the cooler after the cooler has been detached from the stroller frame. Each end of the carrying strap is configured to be coupled to one of the clips provided on either end of the cooler.

In one embodiment, the stroller frame includes a pair of rear legs and a cooler support coupled to the rear legs. The cooler support engages an underside of the cooler to help support the cooler in a selected position alongside the rear wall of the storage basket.

Additional features of the invention will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a juvenile stroller in accordance with the disclosure showing a seat frame, a storage basket positioned to lie below a seat coupled to the seat frame, a pair of anchor mounts coupled to comer portions of a basket support frame, a cooler configured to store items in a cooled environment, a pair of clips coupled to opposite ends of the cooler and adapted to be coupled to the anchor mounts to attach the cooler to the basket support frame, and a carrying strap adapted to be coupled to the cooler clips to facilitate carrying the cooler after it has been detached from the anchor mounts on the basket support frame.

FIG. 2 is an enlarged side elevation of a rear portion of the stroller of FIG. 1 showing the cooler in a mounted position alongside a rear wall of the storage basket;

FIG. 3 is an enlarged plan view, with portions broken away, of one of the anchor mounts and one of the comer portions of the basket support frame taken along line 3-3 of FIG. 2 showing a flange formed to include a hook-receiving aperture therein;

FIG. 4 is a perspective view of a juvenile stroller similar to the stroller shown in FIG. 1 showing another style of anchor mounts coupled to the basket support frame and another style of cooler clips adapted to be coupled to the anchor mounts;

FIG. 5 is an enlarged side elevation of a rear portion of the stroller of FIG. 4;

FIG. 6 is an enlarged plan view, with portions broken away, of one of the anchor mounts of FIG. 4;

FIG. 7 is a perspective view of another juvenile stroller in accordance with the disclosure showing a horizontally extending, U-shaped cooler support extending away from a rear wall of the storage basket to provide a landing for receiving the cooler thereon; and

FIG. 8 is an enlarged side elevation of a rear portion of the stroller of FIG. 7 showing the cooler support engaging an underside of the cooler to support the cooler alongside the rear wall of the storage basket.

### DETAILED DESCRIPTION OF THE DRAWINGS

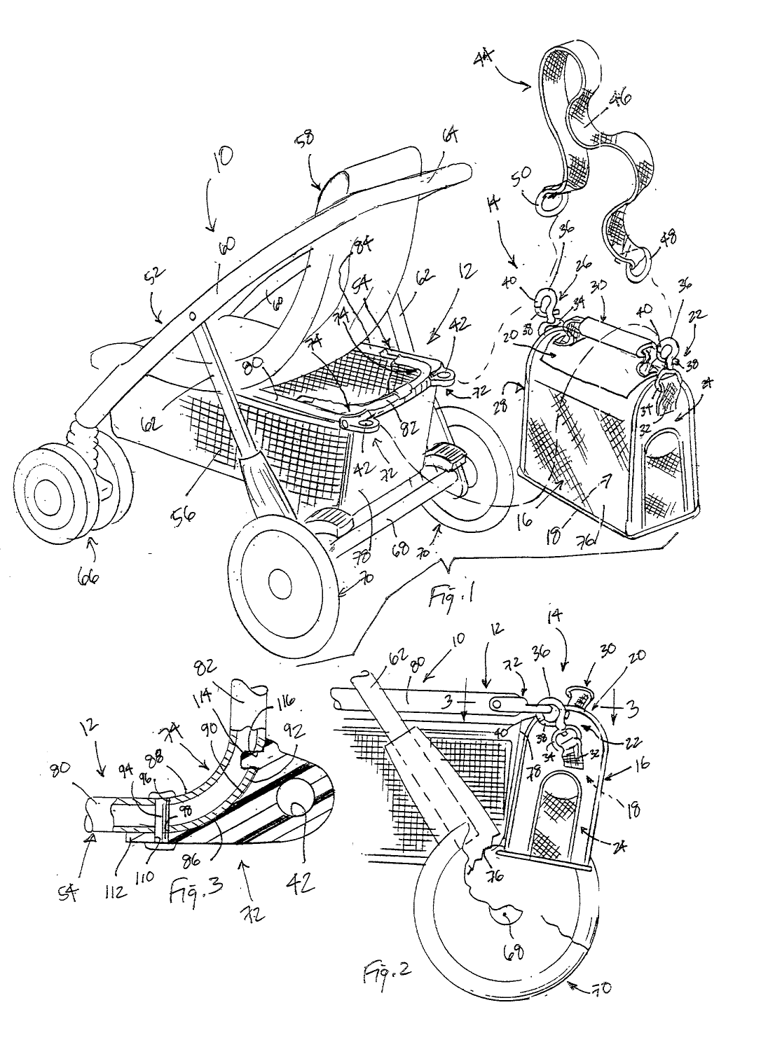

A juvenile stroller 10 includes a stroller frame 12 and a cooler 14 configured to store items in a cooled environment as shown, for example, in FIG. 1. The cooler 14 is coupled to the stroller frame 12 as shown, for example, in FIG. 2 to move therewith as the stroller 10 is pushed by a caregiver.

Cooler 14 includes a cooler body 16 formed to include an interior cold storage region 18 therein and a cooler lid 20. Cooler lid 20 is coupled to cooler body 16 for movement between a closed position (shown in FIGS. 1 and 2) covering an opening into interior cold storage region 18 and an opened position (not shown) uncovering the opening into interior cold storage region 18. Cooler body 16 and lid 20 cooperate to provide a thermally insulated case in which caregivers can store childcare or other items to be maintained in a cooled environment. This thermally insulated case is adapted to receive an ice pack or any other suitable low-temperature source to lower the temperature in interior cold storage region 18 to a selected temperature target or range. Cooler 14 functions as a thermally insulated storage region to maintain products stored therein at a desired temperature relative to an ambient temperature outside the storage region for a desired period of time so that cold products stored in the thermally insulated storage region will be maintained at their temperature and warm products stored in the thermally insulated storage region will be maintained at their warm temperature.

As shown in FIG. 1, a first clip 22 is coupled to a first end 24 of cooler body 16, a second clip 26 is coupled to a second end 28 of cooler body 16, and a handle 30 is coupled to lid 20. Clips 22, 26 are configured to enable a user to link cooler 14 to stroller frame 12 to move therewith. Clips 22, 26 are also configured to be uncoupled from stroller frame 12 to enable a user to detach cooler 14 from stroller frame 12 at the option of the user.

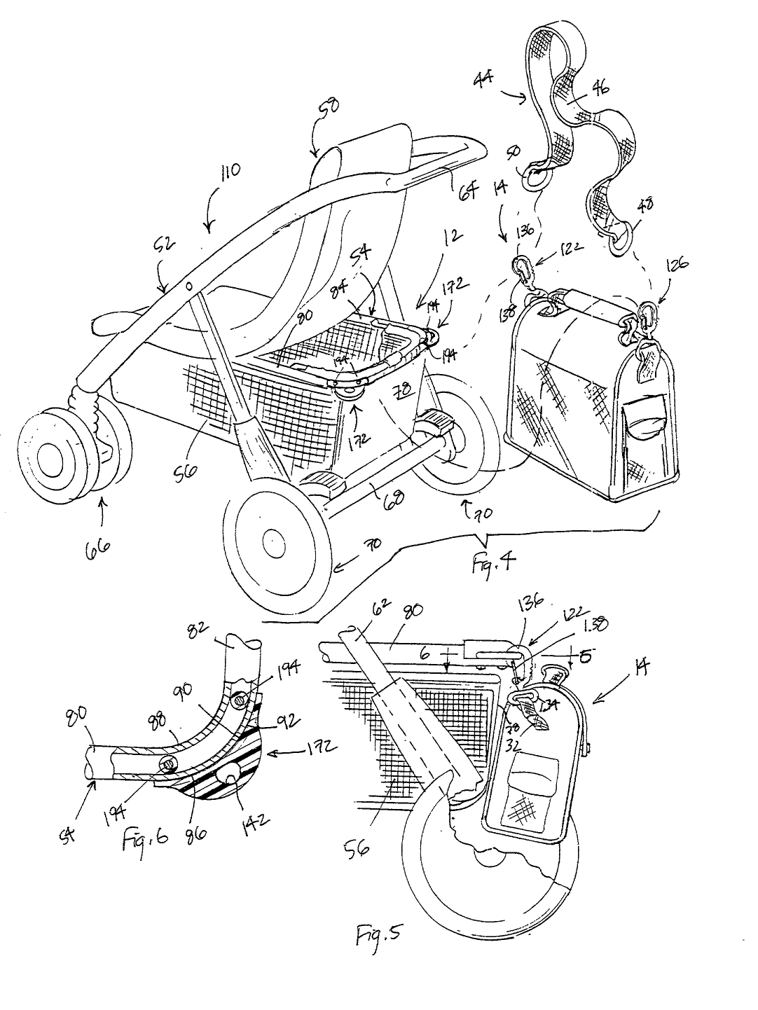

In the illustrated embodiment, each of clips 22, 26 includes a strap 32, a ring 34, a hook 36, and a movable hook guard 38. One end of strap 32 is attached to cooler body 16 and another end of strap 32 is attached to ring 34. Hook 36 is fixed to ring 34 and hook guard 38 is mounted for movement relative to hook 36 to expose a distal end 40 of hook 36 whenever it is desired to pass that distal end 40 through hook-mounting aperture 42 of the type shown, for example, in FIGS. 1 and 3

A carrying strap 44 is provided to facilitate transport of cooler body 16 by a user once cooler body 16 is separated from stroller frame 12. Carrying, strap 44 includes a belt 46, a first ring 48 coupled to one end of belt 46 and adapted to be coupled to hook 36 of first clip 22, and a second ring 50 coupled to another end of belt 46 and adapted to be coupled to hook 36 of second clip 26.

Stroller frame 12 includes a seat frame 52, a basket support frame 54 coupled to seat frame 52, and a storage basket 56 coupled to basket support frame 54. A seat 58 is coupled to seat frame 52 in any suitable manner. It is within the scope of this disclosure to employ a wide variety of seats and seat frames. In the illustrated embodiment, seat frame 52 includes a pair of front legs 60, a pair of rear legs 62, and a push handle 64. A set of front wheels 66 is coupled to each front leg 60 as shown, for example, in FIG. 1 and a rear axle 68 carrying a rear wheel 70 at each end is coupled to rear legs 62 as shown, for example, in FIGS. 1 and 3.

Basket support frame 54 carries one or more anchor mounts 72 as shown, for example in FIGS. 1-3. Each anchor mount 72 is located and configured to couple to one of clips 22, 26 so that cooler 14 is coupled to stroller frame 12 to move therewith as a user pushes stroller 10 to transport a child. Each anchor mount 72 is coupled to a comer portion 74 included in basket support frame 74 so that a rear wall 76 of cooler body 16 will lie alongside a rear wall 78 of storage basket 56 when cooler 14 is coupled to stroller frame 12 to move therewith. It is within the scope of this disclosure to locate anchor mounts 72 in other suitable locations on basket support frame 54 or other portions of stroller frame 12 or seat 58 to enable cooler 14 to move with stroller frame 12.

Basket support frame 54 is made of a tubular member that is bent to form, in series, straight left section 80, left rear comer portion 74, straight rear section 82, right rear comer portion 74, straight right section 84, a front right comer portion (not shown), a straight front section (not shown), and a front left corner portion (not shown). As shown in FIG. 3, each comer portion 74 includes a convex curved outer surface 86 and a concave curved outer surface 88. Storage basket 56 can be coupled to basket support frame 54 in any suitable manner. It is within the scope of this disclosure to form basket support frame 54 and storage basket 56 as a single unit if desired. Basket support frame 54 and storage basket 56 cooperate to form a container, which container can be mounted in any suitable location on stroller frame 12. In the illustrated embodiment, basket support frame 54 is coupled to seat frame 52 to cause a front portion of storage basket 56 to lie under seat 58 and a rear wall 78 of storage basket 56 to lie generally above rear axle 68.

One embodiment of an anchor mount 72 is illustrated in FIG. 3. Anchor mount 72 includes a concave curved outer surface 90 arranged to abut a portion of basket support frame 54. That portion is, for example, a curved tubular member having a convex outer surface 92 configured to mate with concave curved outer surface 90 in a channel defined by outer surface 90. A connector 94 extends through apertures 96, 98 formed in basket support frame 54 and an aperture 110 formed in a flange 112 included in anchor mount 72 to retain anchor mount 72 on basket support frame 54. A lug 114 included in anchor mount 72 can be arranged to project away from concave outer surface 90 and into an aperture 116 formed in convex curved outer surface 92.

Cooler 14 is coupled to anchor mounts 72 as shown, for example, in FIG. 2 so that cooler 14 is attached to stroller frame 12 to move therewith. Clips 22, 26 are coupled to anchor mounts 72 so that cooler 14 hangs in a position located alongside rear wall 78 of storage basket 56 and accessed easily by a user pushing stroller 10. When coupled, hooks 36 included in clips 22, 26 pass through hook-mounting apertures 42 formed in anchor mounts 72. Hook guards 38 can be, moved relative to hooks 36 to enable a user to release hooks 36 from anchor mounts 72 so that cooler 14 can be detached easily from stroller frame 12. Cooler 14 and clips 22, 26 cooperate to provide a portable refrigerator unit that can be coupled to a container 54, 56 to move therewith.

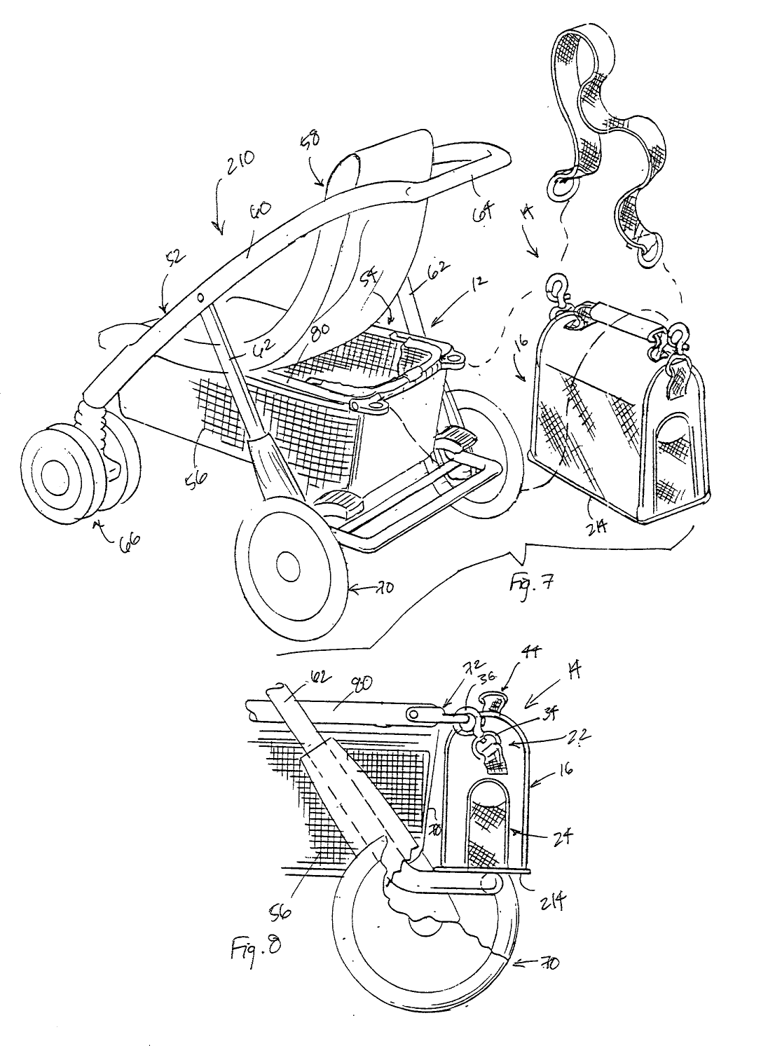

Another type of anchor mount and clp is shown in FIGS. 4-6 for use with stroller 110. Anchor mount 172 is formed to include a hook-mounting aperture 142 and two connectors 194 are passed through apertures formed in anchor mount 172 and basket support frame 54 to couple each anchor mount 172 to stroller frame 12. Each clip 122, 126 included a C-shaped hook 136 and a deflectable hook guard strip 138 having one end coupled to hook 136 and another end movable relative to a distal end of hook 136 to permit a user to attach and detach hook 136 to and from anchor mount 172. Each clip 122, 126 is coupled to a ring 134 as shown, for example, in FIG. 5.

It is within the scope of this disclosure to provide a cooler support 212 in a stroller 210 as shown, for example, in FIG. 7 that is arranged to engage an underside 214 of cooler 14 to help support cooler 14 in a stable position alongside rear wall 78 of storage basket 56 as shown, for example, in FIG. 8. Cooler support 212 is coupled, for example, to rear legs 62 and includes a horizontally extending, U-shaped tubular member that extends away from rear wall 78 of storage basket 56 and lies generally at or below a bottom portion of storage basket 56. It is within the scope of this disclosure to couple cooler support 212 to another part of stroller frame 12 to provide means for supporting cooler 14 in a selected position alongside storage basket 56.

Although the invention has been described in detail with reference to certain preferred embodiments, variations and modifications exist within the scope and spirit of the invention as described and defined in the following claims.

1. A juvenile stroller comprising
a stroller frame,
a thermally insulated cooler configured to store items in a cooled environment, and
attachment means for temporarily coupling the cooler to the stroller frame so that the cooler is attached to the stroller frame to move therewith and is detachable from the stroller frame at the option of a user.

2. The juvenile stroller of claim 1, wherein the attachment means includes a first anchor mount fixed to the stroller frame and a first cooler anchor coupled to the cooler and coupled to the first anchor mount to attach the cooler to the stroller frame.

3. The juvenile stroller of claim 2, wherein the stroller frame includes a seat frame, a basket support frame coupled to the seat frame, and a storage basket coupled to the basket support frame, and the first anchor mount is coupled to the basket support frame.

4. The juvenile stroller of claim 3, wherein the attachment means further includes a second anchor mount coupled to the basket support frame to lie in spaced-apart relation to the first anchor mount and a second cooler anchor coupled to the cooler and to the second anchor mount to support the cooler alongside t he storage basket.

5. The juvenile stroller of claim 3, wherein the stroller frame further includes a rear axle and rear wheels coupled to the rear axle, the stroller further includes a seat coupled to the seat frame, the basket support frame includes a front portion positioned to lie under the seat and a rear portion positioned to lie above the rear axle, and the first anchor mount is coupled to the rear portion of the basket support frame to lie above the rear axle.

6. The juvenile stroller of claim 3, wherein the basket support frame includes a pair of straight sections and a corner portion interposed between the pair of straight sections and the first anchor mount is coupled to the corner portion.

7. The juvenile stroller of claim 2, wherein the first anchor mount includes a concave curved outer surface arranged to abut a portion of the stroller frame.

8. The juvenile stroller of claim 7, wherein the portion of the stroller frame is a curved tubular member having a convex curved outer surface configured to mate with the concave curved outer surface of the first anchor mount and the concave curved outer surface of the first anchor mount is shaped to define a curved channel receiving the convex curved outer surface of the curved tubular member therein.

9. The juvenile stroller of claim 7, wherein the first anchor mount is formed to include an aperture positioned to lie in spaced-apart relation to the portion of the stroller frame and the first cooler anchor includes a hook extending into the aperture.

10. The juvenile stroller of claim 2, wherein the portion of the stroller frame is formed to include first and second apertures, the first anchor mount includes a flange having an outer edge engaging the portion of the stroller frame and a lug extending from the outer edge into the first aperture to locate the flange in a selected position relative to the stroller frame and a connector coupled to the flange and arranged to extend into the second aperture to couple the flange to the stroller frame, and the first cooler anchor is coupled to the flange.

11. The juvenile stroller of claim 10, wherein the portion of the stroller frame is a curved tubular member.

12. The juvenile stroller of claim 10, wherein the stroller frame includes a seat frame, a basket support frame coupled to the seat frame, and a storage basket coupled to the basket support frame, and the basket support frame includes a pair of straight sections and a comer portion interposed between the pair of straight sections and formed to define the portion of the stroller frame that abuts the concave curved outer surface of the first anchor mount.

13. The juvenile stroller of claim 2, wherein the first anchor mount is formed to include an aperture and the first cooler anchor includes a hook extending into the aperture.

14. The juvenile stroller of claim 13, wherein the cooler includes a case formed to include an interior cold storage region adapted to receive items to be cooled, a hook mount coupled to the case and to the hook, and a carrying strap coupled to the hook.

15. The juvenile stroller of claim 2, wherein the attachment means further includes a second anchor mount fixed to the stroller frame and a second cooler anchor coupled to the cooler and coupled to the second anchor mount, the cooler includes a case formed to include an interior cold storage region adapted to receive items to be cooled, the first cooler anchor is coupled to one end of the case, and the second cooler anchor is coupled to another end of the case.

16. The juvenile stroller of claim 15, wherein the case includes a body formed to include the interior cold storage region and a lid coupled to the body for movement between a closed position covering an opening into the inter or cold storage region and an opened position uncovering an opening into the inter or cold storage region, and the lid is positioned to lie in a space between the first and second cooler anchors.

17. A juvenile stroller comprising
a stroller frame,
a container coupled to the stroller frame, and
a portable thermally insulated cooler unit coupled to the container to move therewith.

18. The juvenile stroller of claim 17, wherein the portable thermally insulated cooler unit includes a thermally insulated cooler configured to store items in a cooled environment and a first clip coupled to the cooler and coupled to the container to link the cooler to the container.

19. The juvenile stroller of claim 18, wherein the portable thermally insulated cooler unit further includes a second clip coupled to the cooler and coupled to the container to link the cooler to the container.

20. The juvenile stroller of claim 19, wherein the cooler includes a cooler body formed to include an interior cold storage region and a cooler lid coupled to the cooler body for movement between a closed position covering an opening into the interior cold storage region and an opened position uncovering an opening into the interior cold storage region, and the cooler lid is positioned to lie in a space between the first and second clips.

21. The juvenile stroller of claim 19, wherein the cooler includes a first end coupled to the first clip, a second end coupled to the second clip, and a rear wall arranged to extend between the first and second ends and lie in confronting relation to a rear wall of the container.

22. The juvenile stroller of claim 19, wherein each clip includes a hook configured to hook onto the container and a hook mount coupled to the cooler and to said hook.

23. The juvenile stroller of claim 19, wherein the portable thermally insulated cooler unit further includes a carrying strap coupled to the first and second clips.

24. The juvenile stroller of claim 18, wherein the container includes a basket support frame coupled to the stroller frame, a storage basket coupled to the basket support frame, and a first anchor mount coupled to the basket support frame and to the first clip.

25. The juvenile stroller of claim 24, wherein the first anchor mount is formed to include an aperture and the first clip includes a hook extending into the aperture.

26. The juvenile stroller of claim 24, wherein the stroller frame includes a rear leg and a cooler support coupled to the rear leg to lie below the basket support frame and engage an underside of the cooler to support the cooler in a selected position alongside the storage basket.

27. The juvenile stroller of claim 17, wherein the container includes a basket support frame coupled to the stroller frame and a storage basket coupled to the basket support frame and formed to include a rear wall adapted to face toward a user pushing the stroller and the portable refrigerator unit is arranged to lie alongside the rear wall of the storage basket.

28. The juvenile stroller of claim 27, wherein the stroller frame includes a push handle and a rear axle arranged to lie below the push handle and the portable refrigerator unit is supported to lie above the rear axle and below the push handle.

29. The juvenile stroller of claim 28, wherein the stroller frame further includes a rear leg coupled to the rear axle and a cooler support including a support arm coupled to the rear leg and a support bar coupled to the support arm and arranged to engage an underside of the portable refrigerator unit to support the portable refrigerator unit in a selected position alongside the rear wall of the storage basket.

30. The juvenile stroller of claim 17, wherein the portable thermally insulated cooler unit includes a cooler body formed to include an interior cold storage region and a cooler lid coupled to the cooler body for movement between a closed position covering an opening into the interior cold storage region and an opened position uncovering an opening into the interior cold storage region and arranged to be moved between the closed and opened positions while the portable refrigerator unit is coupled to the container to move therewith.

31. The juvenile stroller of claim 30, wherein the portable thermally insulated cooler unit further includes a pair of clips coupled to the cooler body and configured to hook onto the container to position the cooler body alongside the contain and expose the cooler lid to enable movement of the cooler lid between the closed and opened positions.

32. A juvenile stroller comprising
a stroller frame including front legs, front wheels coupled to the front legs, rear legs, rear wheels mounted for rotation about an axis relative to the rear legs, and a push handle arranged to extend above the rear wheels,
a seat coupled to the stroller frame to move therewith,
a container coupled to the stroller frame and arranged to lie under the seat, the contain including a basket support frame coupled to the stroller frame and a storage basket coupled to the basket support frame, the storage basket including a pair of spaced-apart side walls and a rear wall, each side wall being arranged to extend along a length of the stroller frame between one of the front wheels and one of the rear wheels, the rear wall being arranged to extend between rear ends of the side walls and lie in a space between the rear wheels, and
a portable thermally insulated cooler unit coupled to the basket support frame and arranged to lie alongside the rear wall of the storage basket and below the push handle.
